(19) United States
(12) Patent Application Publication
(10) Pub. No.: US 2009/0074317 A1
(43) Pub. Date: Mar. 19, 2009

(54) SYSTEM AND METHOD FOR REDUCING HALO EFFECT IN IMAGE ENHANCEMENT

(75) Inventor: Sangkeun Lee, Irvine, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Gyeongii-Do (KR)

(21) Appl. No.: 11/857,993

(22) Filed: Sep. 19, 2007

(51) Int. Cl. G06K 9/42

(52) U.S. Cl. 382/256

(57) ABSTRACT

A method of enhancing an image, comprising providing an image having luminescence and at least one boundary, determining locations each of the at least one boundary in the image, computing an image enhancement technique having a gain for application to the image, and adjusting the gain of the image enhancement based on the luminescence values of the image near the boundary locations.

### BACKGROUND

1. Field

The invention relates to image processing and, particularly to the removal of undesirable image effects.

2. Discussion of Related Technology

When processing of images involves applying one of several convolution-based image processing routines affecting the brightness or contrast of an image, there may be present a halo effect at the boundaries of objects in the resulting images. As is well-known in the art, a halo effect at an object boundary is the result of irregularly heightened brightness or large luminescence change in a region on either side of the boundary. Some well-known implementations of image enhancement, such as retinex processing, create this condition. Although the halo effect can be desirable in some images, generally the image quality can be considered degraded by this distortion, resulting in a less appealing image where visual accuracy is desired.

Accordingly, there is a need in the art for a method of image processing that reduces or eliminates the halo effect caused by other image-enhancing techniques.

### SUMMARY

One aspect of the invention is a method of enhancing an image, comprising providing an image having luminescence and at least one boundary; determining locations of the at least one boundary in the image; providing an image enhancement technique having a adjustable gain for application to the image; and adjusting the gain of the image enhancement based on the luminescence values of the image near the boundary locations.

### BRIEF DESCRIPTION OF THE DRAWINGS

FIG. 1 is a block diagram illustrating an embodiment of a system for implementing improved image enhancement.

FIGS. 2A and 2B schematically illustrate a region of an image affected by convolution-based image enhancement.

FIG. 3A schematically illustrates an image boundary exhibiting a halo effect.

FIG. 3B schematically illustrates a representation of the image characteristics of the boundary of FIG. 3A.

FIG. 3C schematically illustrates the representation of FIG. 2B after improvement.

### DETAILED DESCRIPTION OF EMBODIMENTS

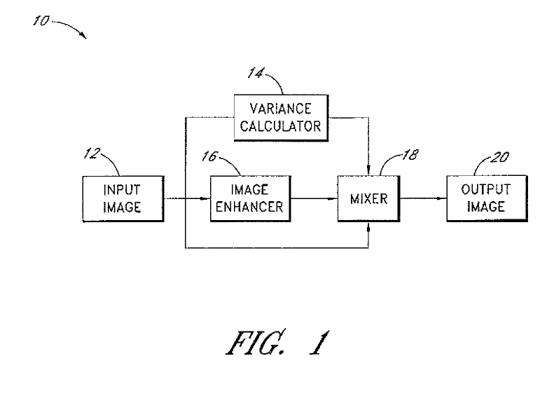

FIG. 1 is a block diagram illustrating an embodiment of an image enhancement system 10. The image enhancement system 10 can have an image input component 12. An enhancement component 16 can perform several types of enhancement, preferably including convolution-type enhancement. Other types of enhancement can be performed by the enhancement component 16 including, without limitation, image sharpening and noise-reduction. The system can further comprise a variance calculator 14, described in greater detail below. A mixer component 18 can receive the original image from the image input 12 as well as input from the enhancement component 16 and the variance calculator 14. The mixer component 18 combines the input from disparate sources to create an output image 20. Other components can be added to the system, including those that prepare the image to be input at the image input 12, or are its source. The mixer component 18 can also receive input from other sources as well.

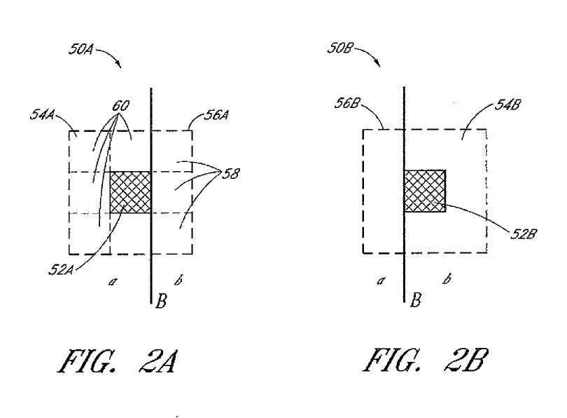

With reference to FIG. 2A, a sample of convolution-type image processing is displayed. An interaction region 50A being altered by a method of image processing is displayed. A pixel block 52A can be the focus of processing. The pixel block 52A can be a single pixel, or any group or collection of pixels into which an image is discretely divided for processing. Some image-processing methods apply a routine or algorithm iteratively over the entire image or a subsection thereof to achieve the desired effect. Thus, certain regions of an image can be selected for processing. As shown, the illustrated region 50A has a pixel block 52A currently undergoing processing. Some processing algorithms that employ convolution can evaluate an evaluation region 54A containing surrounding pixel blocks 58, 60 within a perimeter 56A while processing. In the illustrated embodiment, while processing a pixel block 52A, eight neighboring pixel blocks 58, 60 are evaluated, though fewer or more can be evaluated. In some embodiments, the algorithm can evaluate pixel blocks in an irregular geometric shape, instead of the square perimeter 56A illustrated.

While processing an image, an enhancing method can focus on a pixel block 52A near a boundary B. As a perimeter 56A can include pixel blocks 58, 60 on all sides of the pixel block 52A being processed, some blocks 60 can have image information representative of a first portion a of the image, while other blocks 58 on the other side of the boundary B can have image information consistent with the second portion b of the image across the boundary B. Thus, the image information from the blocks in the first portion a and the second portion b can be widely disparate if the boundary B is between extremely different image regions. Accordingly, when the pixel block 52A is located such that the evaluation region 54A encompasses portions of both a and b, some undesirable skewing can be imparted to the pixel block 52A by the disparate image information. Where the first portion a has a light color and the second portion b has a dark color, the application of a convolution-based enhancing method, including, without limitation, retinex image processing, high-pass filters, and low-pass filters, can result in an undesirable increased luminescence in the pixel block 52A, in excess of that present in either the first or second portions a, b.

With reference to FIG. 2B, similar features are designated with the same component numbers as in FIG. 2A, except that a “B” has been substituted. Similar to FIG. 2A, where the pixel block 52B is located in the second portion b, but sufficiently near the boundary B, the perimeter 56B can contain an evaluation region 54B including image information from both the first and second portions a, b. When such a region 50B is processed by some image-enhancing methods with lighter and darker portions a, b as described with reference to FIG. 2A, the luminescence value of the pixel block 52B can be abnormally low, lower than that of any portion of the region 50B. Accordingly, the increased luminescence resulting from pixel blocks across the boundary B, such as 52A, prominently appears, resulting in a bright region having approximately the shape of the boundary B. This is one embodiment of the halo effect.

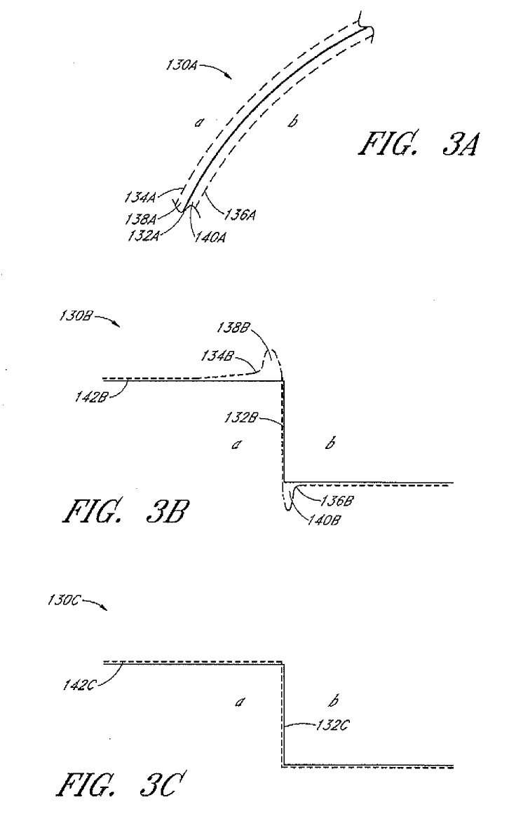

With reference to FIGS. 3A-3C, a boundary portion 130A after processing is illustrated. As shown in FIG. 3A, in some embodiments, the boundary 132A can divide an image into a first and second portions a, b, where a is a lighter portion of the image, and b is a darker portion of the image. After processing, such as that described above, a halo effect can appear as a brightened region 138A extending out to a brightened edge 134A. Similarly, a halo effect can appear as a darkened region 140A extending into the darker portion b to a darkened edge 136A can result.

FIG. 3B schematically illustrates a representation of the boundary portion 130B of FIG. 3A, except that luminescence values near the boundary 132B are illustrated. As can be seen, lighter portion a can have a higher luminescence value than the darker portion b. The drop in luminescence associated with the boundary 132B is also represented. The dashed line shows a post-processing graphical representation of value of luminescence 142B, beginning high in the first portion a and increasing at the brightened edge 134B to produce the brightened region 138B. The value of luminescence 142B then drops at the boundary 132B and continue to descend to create the darkened region 140A, extending to the darkened edge 136B before more closely conforming to the value in the second portion b.

To correct the halo effect, a variance calculator 14 can be utilized in the system 10. A large variance in luminescence value can correspond to the boundary B. As is well-known in the art, the variance is the square of the standard deviation, measuring the deviation in luminescence for a pixel block from the local average. Thus, as variance is evaluated, a large change can indicate the presence of a boundary, a typical location for halo effects, as described above. Thus, the variance can be compared to a threshold value, or more than one threshold values. Where boundaries are detected, the gain of the image enhancement process being performed can be adjusted to reduce or eliminate halo effects. Preferably, the gain is adjusted by incremented amounts to reduce the likelihood of sharp differences in image processing.

In one embodiment, the gain of the image-processing algorithm can be moderated by the formula.

Y(x,y)=[1−ƒ(var(x,y)]*X(x,y)+ƒ(var(x,y))*Xₑₙₕ(x,y)

where (x,y) are coordinates indicating a pixel location, Y is the function for determining the gain value for the image-processing algorithm, X is the value of luminescence of the pixel at the coordinates before processing, Xₑₙₕ is the value of luminescence of the pixel at the coordinates after processing, var(x,y) is the variance of luminescence at the pixel at the coordinates, and ƒ(var(x,y)) is a weighting function with the variance as the input. To determine ƒ(var(x,y)), the variance, σ, is compared against threshold values. There are preferably two threshold values, though more can be used with finer-resolution functions. In one embodiment, threshold values of τ₁ and τ₂ are used. A value for the lower value, τ₁ can be a variance value of 20, though lower values can be used, preferably above 10. A variance value of 40 can be used for τ₂, though higher values can be used, increasing without limit, though practically preferably lower than 100. When a variance less than τ₁ is detected near the boundary, ƒ(var(x,y)) can be set equal to 1, resulting in normal application of the image-processing method. When the variance is greater than τ₂, ƒ(var(x,y)) can be set equal to 0, resulting in a luminescence value equal to that of the pixel in the unprocessed image. For values of variance falling between τ₁ and τ₂, a scaling function can be used. One such function can be:

ƒ(σ)=(τ₂−σ)/(τ₂−τ₁)

which results in a reduced value of ƒ(σ) as the value of σ increases.

When applied to the boundary 132A, 132B shown in FIGS. 3A and 3B, an improved image can be produced. As shown in FIG. 3C, the post-processing value of luminescence 142C can closely follow the values in the first and second portions a, b and track the change associated with the boundary 132C. The brightened and darkened regions 138A, 138B, 140A, 140B are reduced or eliminated, resulting in an image with reduced or no halo effects.

With reference back to FIG. 1, the mixer component 18 can receive the input image 12, the results of image enhancement 14, and the values determined by the variance calculator 14 to synthesize an output image 20, wherein the results of the image enhancement component are adjusted by the values from the variance calculator 14. In some embodiments, other components can contribute information to the mixer to affect the output image 20. In some embodiments, one threshold value can be used, and the level of the gain can be proportional to the difference between the variance and the threshold value. In such embodiments, the gain can be set to 1 when the variance is below the threshold value, and reduced after exceeding the threshold value by a formula such as:

ƒ(σ)=1−(σ−τ₁)/σk)

where k can be any constant used to scale the value of ƒ.

Similarly, in some embodiments, many threshold values can be used to adjust the gain over a correspondingly fine range.

In some embodiments, a computer can be employed to perform the calculations necessary to implement the image enhancement and adjustment thereof. In some embodiments, the processing can be performed by components of an integrated circuit.

The foregoing description sets forth various preferred embodiments and other exemplary but non-limiting embodiments of the inventions disclosed herein. The description gives some details regarding combinations and modes of the disclosed inventions. Other variations, combinations, modifications, modes, and/or applications of the disclosed features and aspects of the embodiments are also within the scope of this disclosure, including those that become apparent to those of skill in the art upon reading this specification. Thus, the scope of the inventions claimed herein should be determined only by a fair reading of the claims that follow.

What is claimed is:

1. A method of enhancing an image, comprising:
providing an image having luminescence and at least one boundary;
determining locations of the at least one boundary in the image;
providing an image enhancement technique having a adjustable gain for application to the image; and
adjusting the gain of the image enhancement based on the luminescence values of the image near the boundary locations.

2. The method of claim 1, wherein determining locations of boundaries comprises comparing the variance of the value of luminescence between a first and second portions of the image to a first predetermined value.

3. The method of claim 2, wherein the variance is further compared to a second predetermined value.

4. The method of claim 3, wherein adjusting the gain of the image enhancement technique comprises adjusting the gain by an amount proportional to the difference between the variance and one of the predetermined values.

5. The method of claim 3, wherein the gain is set to 0 if the variance is greater than either predetermined value.

6. The method of claim 3, wherein the gain is set to 1 if the variance is less than either predetermined value.

7. The method of claim 1, wherein the image enhancement technique is an image sharpening technique.

8. The method of claim 7, wherein the image sharpening technique is retinex.

9. A system for performing image processing, the system comprising:
an image enhancing component configured to perform at least one image manipulation process on image information;
a variance calculating component configured to determine boundary portions in image information; and
a mixer component, configured to receive image enhancement information from the image enhancing component and variance information from the variance calculating component and to process the received information to produce an image having reduce halo effects at image boundary portions.

10. The system of claim 9, wherein the variance calculating component is configured to compare image information to predetermined values so as to determine boundary portions.

11. The system of claim 10, wherein two predetermined values are used to determine boundary portions.

12. The system of claim 10, wherein the image manipulation process is a convolution-based image enhancement process.

13. The system of claim 10, wherein the image manipulation process is a sharpening process.

14. The system of claim 10, wherein the image manipulation process is a brightness adjustment.

15. The system of claim 10, wherein the image manipulation process is a contrast adjustment.

16. The system of claim 10, wherein the image manipulation process can be applied with varying intensities adjusted by a gain.

17. The system of claim 16, wherein the gain is adjusted by the mixer component in response to variance information received from the variance component.
